(19) United States
(12) Patent Application Publication
(10) Pub. No.: US 2021/0264007 A1
(43) Pub. Date: Aug. 26, 2021

(54) AUTHENTICATION METHOD FOR HEAD-MOUNTED DISPLAY

(71) Applicant: Lenovo (Singapore) Pte. Ltd., Singapore (SG)

(72) Inventors: Jonathan Co Lee, Cary, NC (US); Nathan Andrew Hatfield, Raleigh, NC (US); Philip L. Childs, Fort Wayne, IN (US)

(21) Appl. No.: 16/800,747

(22) Filed: Feb. 25, 2020

(51) Int. Cl. G06F 21/32; G06F 21/36; G06F 21/82; G02B 27/01; G06F 3/01

(52) U.S. Cl. CPC G06F 21/32; G06F 21/36; G06F 3/012; G02B 27/0176; G06F 3/013; G06F 21/82

(57) ABSTRACT

One embodiment provides a method, including: detecting, using one or more sensors of an information handling device, at least two biometric inputs provided by a user during an authentication process; authenticating the user responsive to determining that at least one biometric input of the at least two biometric inputs shares a threshold level of similarity with stored biometric information; determining, using a processor, that another biometric input of the at least two biometric inputs does not share the threshold level of similarity with the stored biometric information; and updating the stored biometric information with retained characteristics of the another biometric input. Other aspects are described and claimed.

### BACKGROUND

Wearable information handling devices (“devices”), such as head-mounted displays (“HMDs”), have become increasingly prevalent in modern society. When worn, users are capable of visualizing and/or interacting with augmented reality (“AR”), virtual reality (“VR”), and/or mixed reality (“MR”) content presented on a display of the HMD. These interactions may be facilitated through one or more input methodologies (e.g., gaze input, controller input, gesture input, etc.).

### BRIEF SUMMARY

In summary, one aspect provides a method, comprising: receiving, on an information handling device, an indication to initiate an authentication process; providing, during the authentication process, an authentication query to a user of the information handling device; detecting, from the user, a head-based action in response to the authentication query; determining, using a processor, whether the head-based action matches a stored head-based action for the authentication query; and authenticating the user responsive to determining that the head-based action matches the stored head-based action for the authentication query; wherein the information handling device is a head-mounted display device.

Another aspect provides an information handling device, comprising: at least one sensor; a processor; a memory device that stores instructions executable by the processor to: receive an indication to initiate an authentication process; provide, during the authentication process, an authentication query to a user of the information handling device; detect, from the user, a head-based action in response to the authentication query; determine whether the head-based action matches a stored head-based action for the authentication query; and authenticate the user responsive to determining that the head-based action matches the stored head-based action for the authentication query; wherein the information handling device is a head-mounted display device.

A further aspect provides a product, comprising: a storage device that stores code, the code being executable by a processor and comprising: code that receives an indication to initiate an authentication process; code that provides, during the authentication process, an authentication query to a user; code that detects, from the user, a head-based action in response to the authentication query; code that determines whether the head-based action matches a stored head-based action for the authentication query; and code that authenticates the user responsive to determining that the head-based action matches the stored head-based action for the authentication query.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of authenticating a user on an HMD.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Most conventional HMDs do not authenticate a user prior to granting them access to content. Rather, a user simply has to place an HMD on to interact with content on it. Without proper authentication, users may gain access to potentially private and/or sensitive information without permission from an originator. For those HMDs that do authenticate, the authentication process is facilitated through one or more additional technologies (e.g., retina scanning, fingerprint reading, eye-tracking, etc.) that may be expensive and/or difficult to implement.

Accordingly, an embodiment provides a method for authenticating a user prior to granting them access to HMD content. In an embodiment, an indication to initiate an authentication process may be received at a device (i.e., an HMD). During the authentication process, an embodiment may provide an authentication query to a user and subsequently detect a head-based action in response to the authentication query. The nature of the authentication query and the head-based action may vary and are further described herein. An embodiment may then determine whether the head-based action matches a stored head-based action for the authentication query (e.g., established during a training period, etc.) and thereafter authenticate the user responsive to identifying a match. Once authenticated, the verified user may visualize and/or interact with available AR or VR content on the HMD. Such a method may therefore increase the security of HMDs and prevent unauthorized users from easily gaining access to the HMD and/or content available on the HMD.

The illustrated example embodiments will be best understood by reference to the figures. The following description is intended only by way of example, and simply illustrates certain example embodiments.

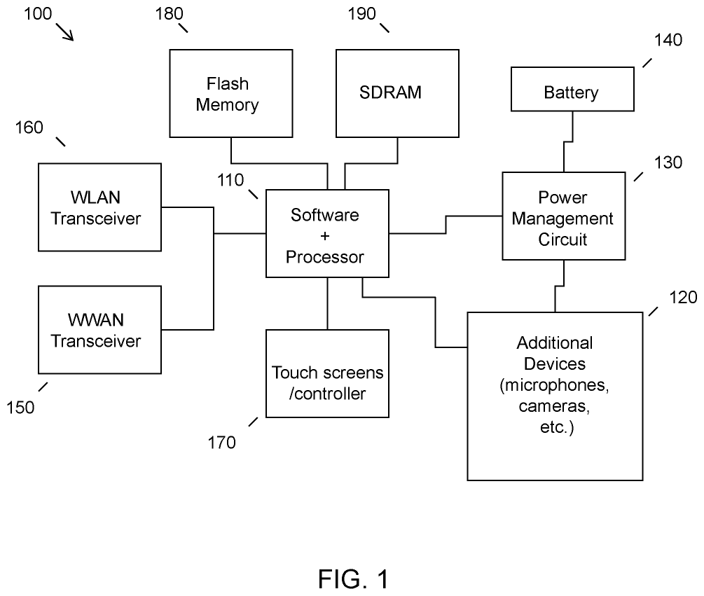

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

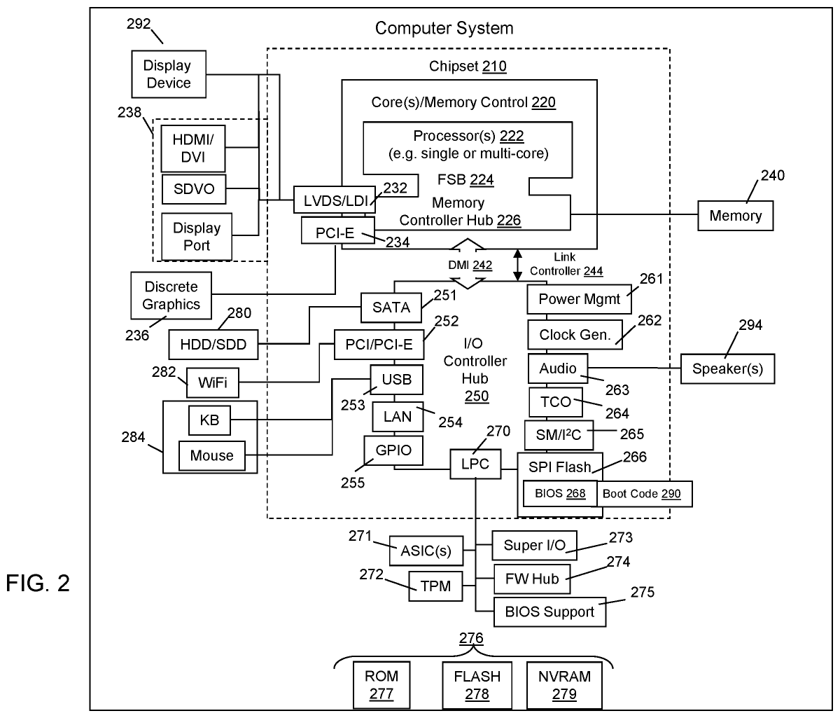

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of displaying and allowing users to interact with AR and/or VR content. For example, the circuitry outlined in FIG. 1 may be implemented in a smart phone or tablet embodiment, whereas the circuitry outlined in FIG. 2 may be implemented in an HMD.

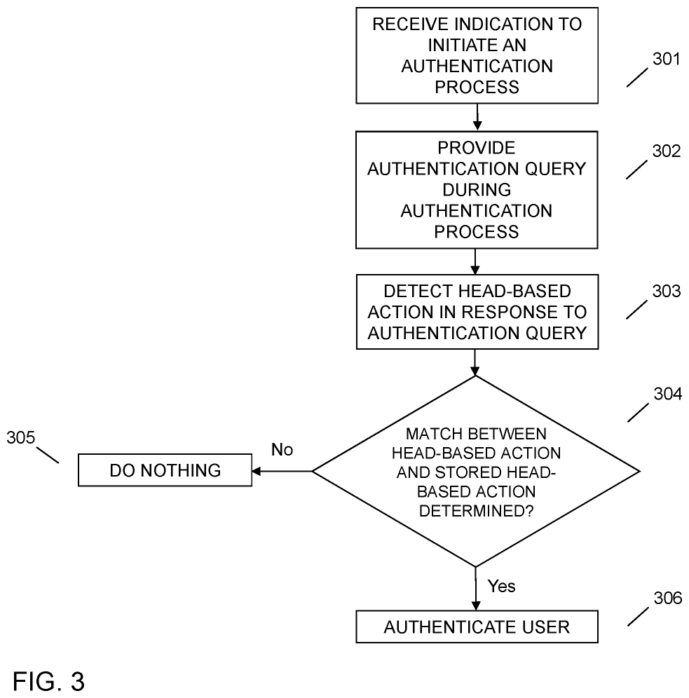

Referring now to FIG. 3, an embodiment provides a method for authenticating a user that desires to interact with content on an HMD. At 301, an embodiment may receive an indication to initiate an authentication process on an HMD. The authentication process may be initiated at various points during device use (e.g., when the device is turned on, when an application on the device is initialized, when a user attempts to interact with or display certain content, etc.).

At 302, an embodiment may provide at least one authentication query to a user during the authentication process. The authentication query may be output to the user using one or more conventional output techniques (e.g., visual output provided on a display screen of the HMD, audible output provided using one or more speakers of the HMD, etc.). The nature of the authentication query may vary according to a desired embodiment. For instance, non-limiting examples of authentication queries that may be implemented may include: image selection, gaze-trace password provision, picture gaze point identification, blink behavior, and emotional response elicitation. Each of the foregoing authentication query types are further elaborated upon below.

Regardless of the structure and format of the query, however, each instance of authentication may demand performance of a certain head-based action by the user. Accordingly, at 303, an embodiment may detect a head-based action in response to the authentication query. In an embodiment, the head-based action may be captured via one or more camera sensors, motion detectors, etc. that are integrally or operatively coupled to the device. The nature of the head-based action may be dictated by the type of authentication query, as further described in the examples below.

At 304, an embodiment may determine whether the head-based action provided by the user matches a stored head-based action for the authentication query. This determination may be facilitated by comparing characteristics of the user-provided head-based action with characteristics of a previously approved head-based action, which may be stored in an accessible database (e.g., locally on the device, remotely on another device or server, etc.). The stored head-based actions in the database may have been previously provided by the user (e.g., during a device training period, etc.). Additionally or alternatively, the stored head-based actions may be dynamically selected by a system of the embodiments (e.g., from the most common crowdsourced head-based action with respect to the nature of the authentication query, from past user behavior, etc.).

Responsive to determining, at 304, that the head-based action does not match a stored head-based action, an embodiment may, at 305, take no additional action. Additionally or alternatively, an embodiment may provide a notification to a user that the answers they provided during the authentication process were incorrect. Furthermore, an embodiment may repeat the authentication process, e.g., by using a new authentication query type, by referring to a new stored head-based action, etc. Conversely, responsive to determining, at 304, that the head-based action does match a stored head-based action, an embodiment may, at 306, authenticate the user.

Pluralities of examples of authentication query types are presented below. These types may be utilized alone or in combination with each other during device use and/or during an authentication process. For example, one authentication query type may be provided to the user at device initialization and another authentication query type may be presented to the user when interacting with a specific application on the device.

In an embodiment, the authentication query may be an image selection query. More particularly, an embodiment may present (e.g., on a display of the HMD, etc.) the user with two or more images and request that they identify an image that they had previously selected as a “passcode image”. The image selection may thereafter be facilitated by identifying that a user's head-gaze was directed toward a particular image for a predetermined period of time (e.g., 2 seconds, 3 seconds, etc.). In certain embodiments, a user may not need to make any explicit designation of a passcode image. Rather, the passcode image in these embodiments may be dynamically selected by a system (e.g., from a user's social media profile, from a user's stored images, from available communication data, etc.). As an example of the foregoing, a user may be presented with 5 pictures of dogs, among which is a picture of the users' dog that was pulled from their social media account. The user may thereafter be prompted to select the image of their dog from the presented images.

An embodiment may increase the layers of image-selection security by introducing additional rounds of image selection. For example, responsive to correctly identifying the passcode image out of 3 presented images, an embodiment may thereafter present the user with another round of 3 different images and prompt them to select the correct passcode image. The determination of the number of images presented in each round and/or the number of rounds a user must progress through prior to being authenticated may be based upon predetermined criteria. For example, one or both of the foregoing conditions may be randomized. Alternatively, one or both of the foregoing conditions may be based upon the designated priority of an application. For example, AR display of financial data may be required to traverse through more rounds of image selection than AR display of non-sensitive content.

In an embodiment, the authentication query may be a password query. More particularly, an embodiment may prompt the user to draw (e.g., using a continuous head-gaze motion, etc.) a predetermined gaze trace password. The gaze trace password may have previously been established by a user (e.g., during a training period during device setup, etc.) via recording a series of head gaze points. In an embodiment, the gaze trace password may correspond to a shape (e.g., circle, triangle, square, etc.) and a system may prompt the user to draw the shape associated with the gaze-trace password (i.e., without explicitly informing the user what that shape is). In response, an embodiment may authenticate the user if a drawn shape has a threshold level of similarity (e.g., 80% similarity, 90% similarity, etc.) to the passcode shape. In this regard, an embodiment may not require the user to reproduce the exact dimensions of the passcode shape, but rather, may simply require the user to trace a shape that is substantially similar to the password shape (i.e., even if the drawn shape is smaller or larger than the predetermined shape). If the correct shape is drawn, the user may then be authenticated.

In another embodiment, the gaze trace password may correspond to a gaze trace passcode path. For example, the passcode path may be as simple as a lined path in which the user looks up to the right, down to the right and back up to the right. This creates three gaze points that are recorded as the user's passcode. Responsive to identifying that a user has correctly traced a path that substantially matches the passcode path, an embodiment may authenticate the user. More elaborate gaze trace paths may of course be created and utilized (e.g., to protect more sensitive information, higher priority applications, etc.). Additionally, a variant embodiment of the foregoing may correspond to a gaze trace path utilizing a dot grid system. More particularly, a user may be presented with a grid of dots on a display of their HMD. The user may thereafter be prompted to trace a particular path by directing their gaze to specific dots that correspond to points along that path.

In an embodiment, the authentication query may be a point selection query. More particularly, an embodiment may present (e.g., on a display of the HMD, etc.) the user with an image or video of a scene comprising at least one object (e.g., a person, an animal, a car, a house, a combination thereof, etc.) and thereafter request the user to gaze at one or more predetermined points in the scene. The predetermined points may correspond to a points-based passcode that was previously established by a user. For example, during a training period a user may have selected 4 unique areas on a painting of an individual to serve as their passcode. Specifically, a user may have gazed at the painted individual's hands, their eyes, their face, and their torso. In an embodiment, authentication may be achieved by a user's subsequent gaze selection of those 4 points. Dependent on a user preference or on a security level (e.g., of the device, of an application on the device, etc.), the selection of the points may either be irrespective or respective of order. More particularly, regarding the former, a user may be authenticated by simply gaze selecting each of the predetermined points, regardless of the order in which they were originally selected. Alternatively, regarding the latter, a user may be authenticated only after gaze selecting the predetermined points in the order in which they were originally selected (e.g., using the foregoing example, by first looking at the painted individual's hands, then their eyes, then their face, etc.).

An embodiment may require the foregoing point selections to be chosen within a predetermined period of time. The predetermined period of time may be arbitrarily assigned (e.g., 10 seconds, 20 seconds, 30 seconds, etc.) or may be dynamically determined. For example, regarding the latter, an embodiment may construct a fixation profile for each image or video that records how long it took a user to select the predetermined points to be used as the passcode. To increase the accuracy of the fixation profile, during the training phase an embodiment may require a user to gaze select the passcode points a predetermined number of times (e.g., 3 times, 5 times, etc.). An embodiment may thereafter assign the average selection time across the predetermined number of times as the predetermined period of time the selections must be completed within.

In an embodiment, the authentication query may be a blink-based combination query. More particularly, an embodiment may request (e.g., on a display of the HMD, using an audio output device, etc.) that the user perform a unique combination of two or more blink behaviors. The unique combination may have been previously established by the user as a type of blink passcode (e.g., during a training period, etc.). For example, the blink passcode may correspond to a blink of the left eye, followed by a blink of the right eye, followed by two blinks with the left eye. If the user executes the unique combination of blink behaviors in the correct order then they may be authenticated. In an embodiment, users may provide an indication to the system that they are ready to provide the blink passcode by performing a type of initiation action (e.g., by closing both eyes for 2 seconds, etc.). Similarly, users may provide an indication to the system that they have finished providing the blink passcode by performing a type of conclusion action (e.g., by closing both eyes for 2 seconds, performing another action with their eyes, etc.). An eye tracker of the device may be able to capture this behavior because the user's eyelids will momentarily block the pupil and cornea from the eye tracker's illuminator.

In an embodiment, the authentication query may be a difference spotting query. More particularly, an embodiment may present (e.g., on a display of the HMD, etc.) the user with an image or video and request that they identify one or more differences between the presented image or video and a stored image or video. Potential differences may include a difference in color, position, size, etc. of one or more objects. As a non-limiting example of the foregoing, a user may be presented with an image of their family (e.g., that was provided to the system by the user, that was dynamically captured from the user's social media data, etc.) and asked to spot any differences. Upon examination of the image, the user may notice they are positioned next to a different individual than in the original image and that their father's shirt is a different color than in the original image. Responsive to correctly communicating the differences between the presented image and the original image to the system (e.g., by gaze selecting on the different objects, etc.), an embodiment may authenticate the user. In an embodiment, the number of correct differences that must be identified may be dependent upon a security level of the device or application (e.g., a higher number of differences must be identified for a higher priority application, etc.).

In an embodiment, the authentication query may not be a query in the conventional sense, but rather, may correspond to an emotional response monitor. More particularly, an embodiment may provide (e.g., on a display of the HMD, through one or more speakers of the HMD, etc.) an article of visual and/or audio content to the user. An embodiment may obtain knowledge of a user's relationship to a subject or theme in the media article and leverage this relationship to determine whether an exhibited emotional response corresponds to an expected emotional response. For instance, subsequent provision of the media, an embodiment may monitor for an emotional response from the user by examining the behavior of the user's eyes (e.g., change in pupil dilation, elicitation of tears, etc.). If the detected emotional response matches an expected or predicted emotional response based upon the presented article of media, then an embodiment may authenticate the user.

As a non-limiting example of the foregoing concept, an embodiment may present the user with an image of the user hugging a previously disconnected family member. An embodiment may expect that the presentation of this image may trigger a strong positive emotional response and may examine the changes in the user's eyes to determine whether those changes correspond to known eye behavior that is associated with positive feelings. If an embodiment concludes that a match between exhibited and expected behavior exists, the user may be authenticated.

In an embodiment, the gaze-based passcodes described herein may be passed to another user to access confidential content. For instance, a certain type of authentication query process may be initiated when access to a particular document is requested. An originator of the document could provide a document-accessing user with the correct gaze-based passcode to successfully progress through the authentication process in order to see the contents of the document. In an embodiment, if the gaze-based passcode and document are cloud-based, the originator may have the option to change the gaze-based passcode (e.g., either time-based or manually, etc.) which would lock the document from being opened.

The various embodiments described herein thus represent a technical improvement to conventional methods of authenticating a user on an HMD. Using the techniques described herein, an embodiment may receive an indication to initiate an authentication process. During the authentication process, an embodiment may provide the user with an authentication query that demands performance of a certain head-based action. If an embodiment determines that the provided head-based action substantially matches a stored head-based action for the authentication query, an embodiment may authenticate the user and grant them access to the device and/or requested content on the device. Such a method may improve the security of current HMD devices.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, on an information handling device, an indication to initiate an authentication process;
providing, during the authentication process, an authentication query to a user of the information handling device;
detecting, from the user, a head-based action in response to the authentication query;
determining, using a processor, whether the head-based action matches a stored head-based action for the authentication query; and
authenticating the user responsive to determining that the head-based action matches the stored head-based action for the authentication query;
wherein the information handling device is a head-mounted display device.

2. The method of claim 1, wherein:
the authentication query is an image selection query that demands selection of at least one image, from a plurality of images, that is associated with the user;
the head-based action is a gaze selection action; and
the stored head-based action corresponds to gaze selection of the at least one image associated with the user.

3. The method of claim 1, wherein:
the authentication query is a password query that demands receipt of a gaze-traced password;
the head-based action is a gaze trace action; and
the stored head-based action corresponds to gaze trace of the gaze-traced password.

4. The method of claim 3, wherein the gaze-traced password corresponds to at least one of: a predetermined shape and a predetermined dot-grid path.

5. The method of claim 1, wherein:
the authentication query is a point selection query that demands selection of at least one point on an object present in one of: an image and a video;
the head-based action is a gaze selection action; and
the stored head-based action corresponds to gaze selection of the at least one point on the object.

6. The method of claim 5, wherein the point selection query demands selection of the at least one point on the object within a predetermined period of time.

7. The method of claim 1, wherein:
the authentication query is a blink-based combination query that demands performance of a predetermined pattern of blinks;
the head-based action is a blink action; and
the stored head-based action corresponds to performance of the predetermined pattern of links.

8. The method of claim 1, wherein:
the authentication query corresponds to provision of a media file;
the head-based action is an emotional action; and
the stored head-based action corresponds to a predicted emotional action based on the media file.

9. The method of claim 1, wherein:
the authentication query is a difference spotting query that demands identification of at least one difference between a current image and a previous image;
the head-based action is a gaze selection action; and
the stored head-based action corresponds to gaze selection on the at least one difference.

10. The method of claim 9, wherein the at least one difference is a difference selected from the group consisting of a color difference, a positional difference, and a size difference.

11. An information handling device, comprising:
at least one sensor;
a processor;
a memory device that stores instructions executable by the processor to:
receive an indication to initiate an authentication process;
provide, during the authentication process, an authentication query to a user of the information handling device;
detect, from the user, a head-based action in response to the authentication query;
determine whether the head-based action matches a stored head-based action for the authentication query; and
authenticate the user responsive to determining that the head-based action matches the stored head-based action for the authentication query;
wherein the information handling device is a head-mounted display device.

12. The information handling device of claim 11, wherein:
the authentication query is an image selection query that demands selection of at least one image, from a plurality of images, that is associated with the user;
the head-based action is a gaze selection action; and
the stored head-based action corresponds to gaze selection of the at least one image associated with the user.

13. The information handling device of claim 11, wherein:
the authentication query is a password query that demands receipt of a gaze-traced password;
the head-based action is a gaze trace action; and
the stored head-based action corresponds to gaze trace of the gaze-traced password.

14. The information handling device of claim 13, wherein the gaze-traced password corresponds to at least one of: a predetermined shape and a predetermined dot-grid path.

15. The information handling device of claim 11, wherein:
the authentication query is a point selection query that demands selection of at least one point on an object present in one of: an image and a video;
the head-based action is a gaze selection action; and
the stored head-based action corresponds to gaze selection of the at least one point on the object.

16. The information handling device of claim 15, wherein the point selection query demands selection of the at least one point on the object within a predetermined period of time.

17. The information handling device of claim 11, wherein:
the authentication query is a blink-based combination query that demands performance of a predetermined pattern of blinks;
the head-based action is a blink action; and
the stored head-based action corresponds to performance of the predetermined pattern of links.

18. The information handling device of claim 11, wherein:
the authentication query corresponds to provision of a media file;
the head-based action is an emotional action; and
the stored head-based action corresponds to a predicted emotional action based on the media file.

19. The information handling device of claim 11, wherein:
the authentication query is a difference spotting query that demands identification of at least one difference between a current image and a previous image;
the head-based action is a gaze selection action; and
the stored head-based action corresponds to gaze selection on the at least one difference.

20. A product, comprising:
a storage device that stores code, the code being executable by a processor and comprising:
code that receives an indication to initiate an authentication process;
code that provides, during the authentication process, an authentication query to a user;
code that detects, from the user, a head-based action in response to the authentication query;
code that determines whether the head-based action matches a stored head-based action for the authentication query; and
code that authenticates the user responsive to determining that the head-based action matches the stored head-based action for the authentication query.
